(19) United States
(12) Patent Application Publication
(10) Pub. No.: US 2021/0342876 A1
(43) Pub. Date: Nov. 4, 2021

(54) REGISTRATION SYSTEM, REGISTRATION METHOD, AND NON-TRANSITORY STORAGE MEDIUM

(71) Applicant: NEC CORPORATION, Tokyo (JP)

(72) Inventors: Itsumi HANEDA, Tokyo (JP); Yasuhito OTSUKA, Tokyo (JP); Mieko HASEGAWA, Tokyo (JP)

(73) Assignee: NEC CORPORATION, Tokyo (JP)

(21) Appl. No.: 17/053,233

(22) PCT Filed: Feb. 1, 2019
(86) PCT No.: PCT/JP2019/003577

§ 371 Date: Nov. 5, 2020

(30) Foreign Application Priority Data
May 9, 2018 (JP) 2018-090748

(51) Int. Cl. G06Q 30/02; G06T 7/00; G06T 7/73

(52) U.S. Cl. CPC G06Q 30/0238; G06T 2207/30204; G06T 7/73; G06T 7/0004

(57) ABSTRACT

The present invention provides a registration system (100) including an acquisition unit (10) that acquires an image including a product from a imaging unit, and an output unit (30) that outputs, when at least a part of a mark including discount information related to the product is included in the image, but the discount information cannot be acquired by an image analysis, guidance information for acquiring the discount information.

### TECHNICAL FIELD

The present invention relates to a registration system, a registration method, and a program.

### BACKGROUND ART

A product that satisfies a predetermined condition such as an approaching expiration date or an approaching best before date is sold at a discount. Then, as one example of practice, a technique is used in which a discount sticker or the like is attached to the product to be discounted and thereby a customer and a salesclerk of a store are clearly notified that a product is to be discounted. Further, in recent years, it has been considered that a discount sticker and the like attached to a product to be discounted are recognized by an image analysis. A related technique is disclosed in PTLs 1 to 3.

PTL 1 discloses that whether a product is a target product of a service label is registered in advance, and, when a product is a service label target, control is performed in such a way as to recognize the service label, and, when the service label cannot be recognized from a product being a service label target, a message such as “Is a discount label attached?” is displayed on a salesclerk display.

PTL 2 discloses a technique for recognizing, by an image analysis, a discount sticker and the like attached to a product, and reflecting the result in checkout processing.

PTL 3 discloses a technique for registering selling-related information such as age, gender, and a discount rate in association by recognizing a position of a human hand and a position of tongs.

### RELATED DOCUMENT

### Patent Document

[PTL 1] Japanese Patent Application Publication No. 2015-207313
[PTL 2] Japanese Patent Application Publication No. 2017-41271
[PTL 3] Japanese Patent Application Publication No. 2016-110480

### SUMMARY OF INVENTION

### Technical Problem

A store that conducts discount sales desires a means for reliably discounting and selling a product without failing to notice presence of a discount sticker and the like.

In a case of the technique described in PTL 1, whether or not a product is a target product of a service label needs to be registered in advance, and thus time and effort are required. In a case of the technique described in PTL 2 of recognizing, by an image analysis, a discount sticker and the like attached to a product, time and effort for advance registration can be avoided. However, a situation where a discount sticker cannot be recognized by the image analysis may occur due to some sort of reason such as “a part of the discount sticker is hidden by a hand” even though the discount sticker is attached to a product. In this case, the product is sold without a discount.

The technique described in PTL 3 is not a technique for detecting a discount sticker and the like attached to a product.

An object of the present invention is to suppress inconvenience of selling a product being a discount target without giving a discount, even without advance registration of the product being the discount target.

### Solution to Problem

The present invention provides a registration system that includes an acquisition unit that acquires an image including a product from a imaging unit, and an output unit that outputs, when at least a part of a mark including discount information related to the product is included in the image, but the discount information cannot be acquired by an image analysis, guidance information for acquiring the discount information.

Further, the present invention provides a registration method executed by a computer, the method including

an acquisition step of acquiring an image including a product from a imaging unit, and

an output step of outputting, when at least a part of a mark including discount information related to the product is included in the image, but the discount information cannot be acquired by an image analysis, guidance information for acquiring the discount information.

Further, the present invention provides a program causing a computer to function as

an acquisition unit that acquires an image including a product from a imaging unit, and

an output unit that outputs, when at least a part of a mark including discount information related to the product is included in the image, but the discount information cannot be acquired by an image analysis, guidance information for acquiring the discount information.

### Advantageous Effects of Invention

The present invention is able to suppress inconvenience of selling a product being a discount target without giving a discount, even without advance registration of the product being the discount target.

### BRIEF DESCRIPTION OF DRAWINGS

The above-described object, the other objects, features, and advantages will become more apparent from suitable example embodiments described below and the following accompanying drawings.

FIG. 1 is a diagram schematically illustrating one example of a mark M according to the present example embodiment.

FIG. 2 is a diagram illustrating one example of a functional block diagram of a registration system according to the present example embodiment.

FIG. 3 is a diagram illustrating one example of a hardware configuration of an apparatus according to the present example embodiment.

FIG. 4 is a flowchart illustrating one example of a flow of processing of the registration system according to the present example embodiment.

FIG. 5 is a diagram illustrating one example of a functional block diagram of the registration system according to the present example embodiment.

FIG. 6 is a diagram illustrating one example of a functional block diagram of an image analysis unit according to the present example embodiment.

FIG. 7 is a diagram schematically illustrating one example of a photographing system for photographing a product being a checkout target.

FIG. 8 is a diagram schematically illustrating one example of the photographing system for photographing a product being a checkout target.

FIG. 9 is a flowchart illustrating one example of a flow of processing of the registration system according to the present example embodiment.

FIG. 10 is a diagram illustrating one example of processing of the registration system according to the present example embodiment.

FIG. 11 is a diagram illustrating one example of processing of the registration system according to the present example embodiment.

### EXAMPLE EMBODIMENT

### First Example Embodiment

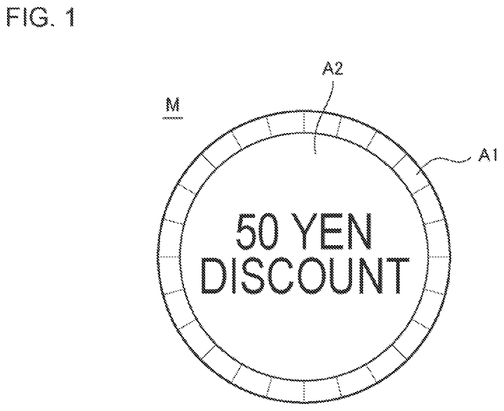

First, an outline of a registration system according to the present example embodiment will be described. In checkout work using the registration system according to the present example embodiment, a mark M including discount information as illustrated in FIG. 1 is attached to a product being a discount target. The mark M may be a sticker. The illustrated discount information is “50 yen discount” and is formed of characters. It should be noted that the illustrated mark M is merely one example, and the invention is not limited thereto. For example, a content of the discount information, a shape of the mark M, and the like can be another configuration.

The registration system according to the present example embodiment analyzes an image generated by a camera that photographs a product being a checkout target, and recognizes the mark M attached to the product. Then, when it is recognized that at least a part of the mark M is included in the image, but discount information included in the mark M cannot be acquired, the registration system outputs guidance information for acquiring the discount information.

In this manner, the registration system according to the present example embodiment for acquiring the discount information by an image analysis is able to suppress inconvenience of selling a product being a discount target without giving a discount, without advance registration of the product being the discount target. Further, the registration system according to the present example embodiment which outputs guidance information for acquiring discount information in a case where it is recognized that at least a part of the mark M is included in an image even when the discount information cannot be acquired is able to suppress inconvenience of selling a product being a discount target without giving a discount even though a discount sticker is actually attached to the product.

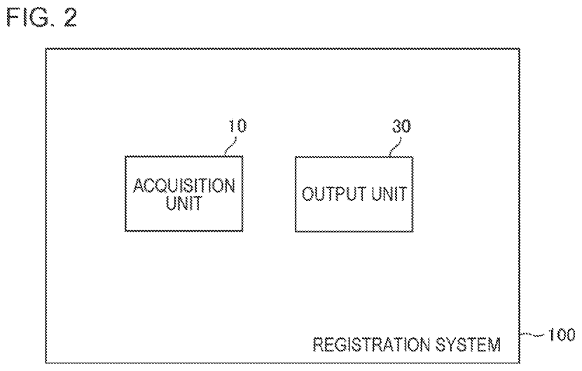

Next, a configuration of a registration system 100 will be described in detail. FIG. 2 is one example of a functional block diagram of the registration system 100. As illustrated, the registration system 100 includes an acquisition unit 10 and an output unit 30.

It should be noted that the registration system 100 may be constituted by a plurality of apparatuses separated physically and/or logically, and may be constituted by one apparatus physically and/or logically. When the registration system 100 is constituted by a plurality of apparatuses separated physically and/or logically, the plurality of apparatuses are configured to be communicable to each other in a wired and/or wireless manner.

The functional units of the registration system 100 are achieved by any combination of hardware and software centering on a central processing unit (CPU) of any computer, a memory, a program loaded into the memory, a storage unit such as a hard disk that stores the program (that can also store a program downloaded from a storage medium such as a compact disc (CD), a server on the Internet, and the like in addition to a program stored in advance at a stage of shipping of an apparatus), and a network connection interface. Then, various modification examples of achievement method and apparatus thereof are understood by a person skilled in the art.

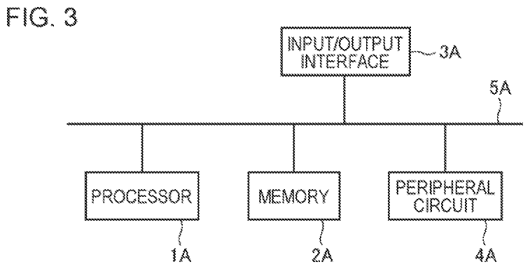

FIG. 3 is a block diagram illustrating a hardware configuration of the registration system 100. As illustrated in FIG. 3, the registration system 100 includes a processor 1A, a memory 2A, an input/output interface 3A, a peripheral circuit 4A, and a bus 5A. Various modules are included in the peripheral circuit 4A. The peripheral circuit 4A may not be provided. It should be noted that, when the registration system 100 is constituted by a plurality of apparatuses separated physically and/or logically, each of the apparatuses can include the hardware configuration.

The bus 5A is a data transmission path for the processor 1A, the memory 2A, the peripheral circuit 4A, and the input/output interface 3A to transmit and receive data to and from each other. The processor 1A is an arithmetic processing unit such as a central processing unit (CPU) and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, and the like, an interface for outputting information to an output apparatus, the external apparatus, the external server, and the like, and the like. The input apparatus is, for example, a keyboard, a mouse, a microphone, and the like. The output apparatus is, for example, a display, a speaker, a printer, a mailer, and the like. The processor 1A can output an instruction to each of modules, and perform a computation, based on an arithmetic result of the modules.

Next, a functional configuration of each of the functional units illustrated in FIG. 2 will be described.

The acquisition unit 10 acquires an image including a product from a imaging unit for photographing a product. The imaging unit is a camera that generates a moving image or a still image. Hereinafter, an image generated by the camera and acquired by the acquisition unit 10 is referred to as a “photographed image”.

When at least a part of the mark M is included in a photographed image, but discount information included in the mark M cannot be acquired by an image analysis, the output unit 30 outputs guidance information for acquiring the discount information. The guidance information only has to be information enabling the registration system 100 to acquire the discount information, and details thereof vary. A specific example is indicated in the following example embodiment.

The output unit 30 can output the guidance information via any output apparatus such as a display and a speaker. Processing of recognizing at least a part of the mark M being included in a photographed image by an image analysis and processing of acquiring discount information included in the mark M by the image analysis may be performed by the registration system 100, or may be performed by an external apparatus configured to be communicable with the registration system 100.

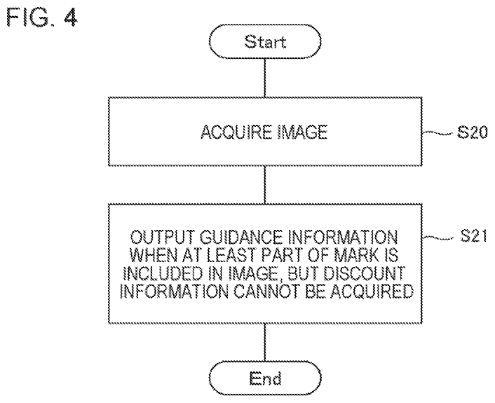

Next, a flow of processing of the registration system 100 will be described by using a flowchart in FIG. 4.

In S20, the acquisition unit 10 acquires a photographed image including a product from the imaging unit. In S21, when at least a part of the mark M including discount information related to the product is included in the photographed image, but the discount information cannot be acquired, the output unit 30 outputs guidance information for acquiring the discount information.

As described above, the registration system 100 according to the present example embodiment which acquires discount information by an image analysis is able to suppress inconvenience of selling a product being a discount target without giving a discount, without advance registration of the product being the discount target. Further, the registration system 100 according to the present example embodiment which outputs guidance information for acquiring discount information in a case where it is recognized that at least a part of the mark M is included in an image even when the discount information cannot be acquired is able to suppress inconvenience of selling a product being a discount target without giving a discount even though a discount sticker is actually attached to the product.

### Second Example Embodiment

A registration system 100 according to the present example embodiment performs processing similar to that of the registration system 100 according to the first example embodiment, but a processing content is more specific.

One example of a hardware configuration of the registration system 100 according to the present example embodiment is similar to that in the first example embodiment.

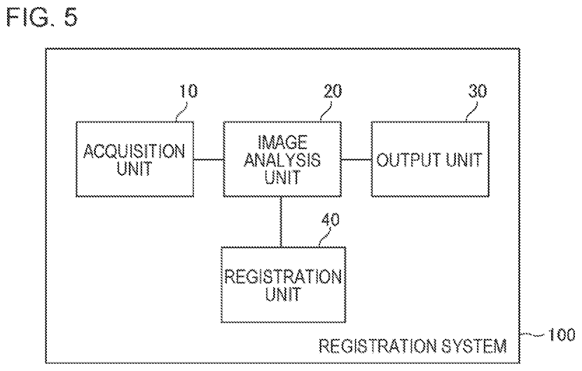

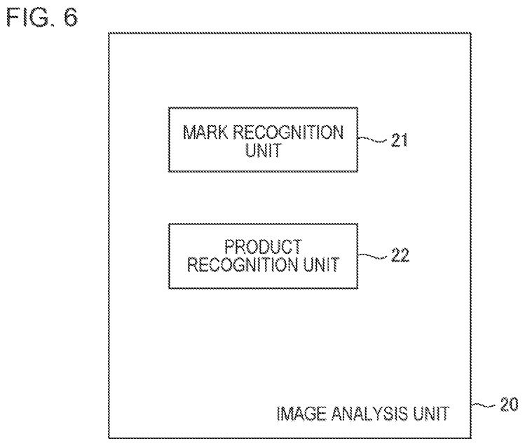

FIG. 5 is one example of a functional block diagram of the registration system 100 according to the present example embodiment. As illustrated, the registration system 100 includes an acquisition unit 10, an image analysis unit 20, an output unit 30, and a registration unit 40. FIG. 6 is one example of a functional block diagram of the image analysis unit 20. As illustrated, the image analysis unit 20 includes a mark recognition unit 21 and a product recognition unit 22.

It should be noted that the registration system 100 may be constituted by a plurality of apparatuses separated physically and/or logically, and may be constituted by one apparatus physically and/or logically. When the registration system 100 is constituted by a plurality of apparatuses separated physically and/or logically, the plurality of apparatuses are configured to be communicable to each other in a wired and/or wireless manner.

The acquisition unit 10 acquires a photographed image including a product from a imaging unit for photographing a product, similarly to the first example embodiment. The imaging unit is a camera that generates a moving image or a still image.

For example, a photographing system including a pedestal on which a product being a checkout target is placed and a camera that photographs a placement surface of the pedestal may be used. Then, the acquisition unit 10 may acquire a photographed image generated by the camera.

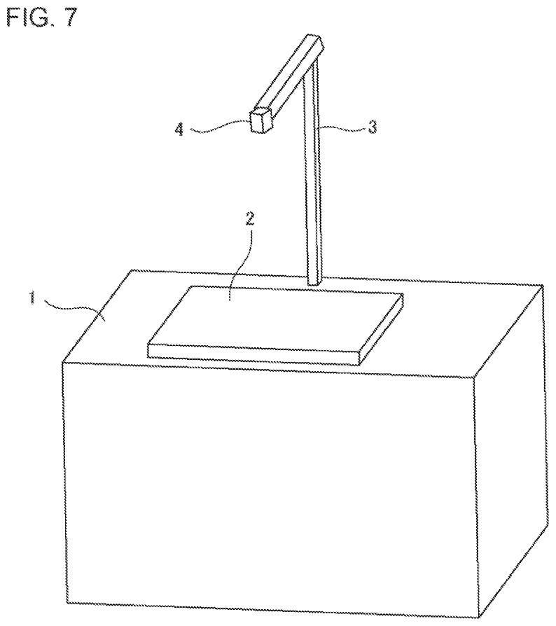

One example of the photographing system is illustrated in FIG. 7. The photographing system illustrated in FIG. 7 includes a pedestal 1, a member 2, a pole 3, and a camera 4. The member 2 is located on an upper surface of the pedestal 1, and constitutes a part of the pedestal 1. An exposed surface of the member 2 is a placement surface on which a product is placed. In other words, an operator places a product being a checkout target on the exposed surface of the member 2. It should be noted that the member 2 may be a display, and may be another member.

The camera 4 is attached to the pole 3, and photographs the exposed surface of the member 2 from above. A photographed image generated by the camera 4 is transmitted to the registration system 100 through wired and/or wireless communication. The acquisition unit 10 can acquire the photographed image.

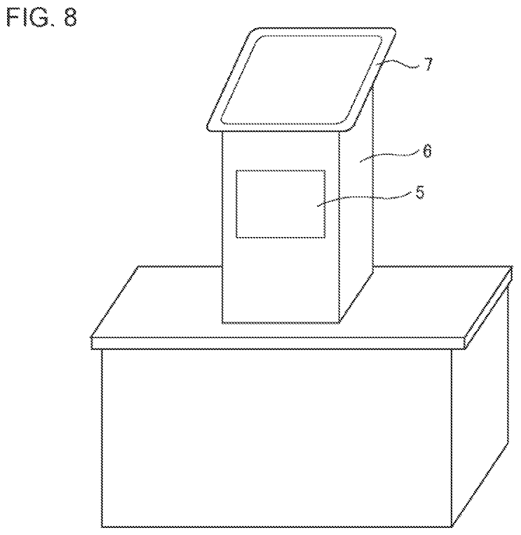

In addition, a photographing system for generating a photographed image including each one of products in response to each product being held in front of a camera may be used. One example of the photographing system is illustrated in FIG. 8. The photographing system illustrated in FIG. 8 includes a reading window 5, a housing 6, and a display 7. A not-illustrated camera is installed in the housing 6. The reading window 5 is configured to pass light. The camera photographs a product held in front of the reading window 5 via the reading window 5. A photographed image generated by the camera is transmitted to the not-illustrated registration system 100 through wired and/or wireless communication. The acquisition unit 10 can acquire the photographed image.

The image analysis unit 20 illustrated in FIG. 5 analyzes a photographed image acquired by the acquisition unit 10. The product recognition unit 22 illustrated in FIG. 6 recognizes a product included in a photographed image by using a pattern matching technique and the like. For example, the product recognition unit 22 detects an object included in a photographed image by using a technique such as binarization of an image and extraction of a contour line. Subsequently, the product recognition unit 22 determines which product the detected object is by comparing a feature of an appearance of the detected object appearing in the photographed image with a feature of an appearance of each of a plurality of products being registered in advance. For example, the product recognition unit 22 may calculate a similarity degree with the detected object for each of the products being registered in advance. Then, the product recognition unit 22 may determine a product having the highest similarity degree with the detected object, or a product having the highest similarity degree with the object and having the similarity degree equal to or more than a reference value. For a feature of an appearance of a product, a color, irregularities on a surface, a shape, and the like are exemplified, but the feature is not limited to these.

In addition, the product recognition unit 22 may detect an object included in a photographed image, and then detect a code such as a bar code and a two-dimensional code by using a pattern matching technique and the like from a region in the photographed image in which the object is present. Then, the product recognition unit 22 may analyze the detected code, convert a pattern of the code into information, and thus acquire product identification information indicated by the code. The product identification information only has to be information that can identify a product, and a product number, a product name, and the like are exemplified.

The mark recognition unit 21 illustrated in FIG. 6 recognizes at least a part of a mark M being included in a photographed image, by using a pattern matching technique and the like, for example. Then, when it can be recognized that at least a part of the mark M is included in the photographed image, the mark recognition unit 21 acquires discount information included in the mark M, by using a character recognition technique and the like, for example.

Herein, a configuration example of the mark M will be described. FIG. 1 schematically illustrates one example of the mark M. The illustrated mark M is circular, and is formed of a pattern region A1 and an information region A2. In the pattern region A1, a characteristic pattern is drawn. In the information region A2, discount information is indicated. The illustrated discount information is “50 yen discount” and is formed of characters.

It should be noted that the illustrated mark M is merely one example, and the invention is not limited thereto. For example, a content of the discount information, a pattern of the pattern region A1, a shape and an area distribution of each of the pattern region A1 and the information region A2, a shape of the mark M, and the like can be another configuration.

Next, one example of a means for recognizing at least a part of the mark M being included in a photographed image will be described. It should be noted that the example is merely one example, and the invention is not limited thereto.

For example, by comparing a template image indicating at least a part of the mark M with a photographed image acquired by the acquisition unit 10, and recognizing presence of a region that coincides with the template image in the photographed image, the mark recognition unit 21 may recognize at least a part of the mark M being included in the photographed image. The coincidence with the template image may be a complete coincidence, or may be a concept including a similarity degree equal to or more than a threshold value in addition to the complete coincidence.

It should be noted that the mark recognition unit 21 may limit a target to be compared with the template image to a region in the photographed image in which presence of an object is recognized by the product recognition unit 22. In addition, the mark recognition unit 21 may limit a target to be compared with the template image to a region in the photographed image in which an object determined to be which product by the product recognition unit 22 is present.

In addition, the mark recognition unit 21 may recognize at least a part of the mark M being included in the photographed image by recognizing presence of a region indicating a pattern of the pattern region A1 of the mark M in the photographed image.

It should be noted that the mark recognition unit 21 may limit a target to be searched for a region indicating a pattern of the pattern region A1 to a region in the photographed image in which presence of an object is recognized by the product recognition unit 22. In addition, the mark recognition unit 21 may limit a target to be searched for a region indicating a pattern of the pattern region A1 to a region in the photographed image in which an object detected to be which product by the product recognition unit 22 is present.

Next, one example of a means for acquiring discount information by the mark recognition unit 21 will be described. It should be noted that the example is merely one example, and the invention is not limited thereto. For example, the mark recognition unit 21 can acquire discount information included in the mark M by performing character recognition processing on a region in a photographed image in which the mark M is present.

When it is recognized that at least a part of the mark M is included in the photographed image by comparison processing using a template image indicating at least a part of the mark M, a region in the photographed image that coincides with the template image may be set as a target region subjected to the character recognition processing.

In addition, when it is recognized that at least a part of the mark M is included in the photographed image by recognizing presence of a region indicating a pattern of the pattern region A1 in the photographed image, a target region subjected to the character recognition processing may be determined based on the region in the photographed image indicating the pattern of the pattern region A1.

For example, when the region in the photographed image indicating the pattern of the pattern region A1 draws a circumference of a circle similarly to the pattern region A1 illustrated in FIG. 1, the mark recognition unit 21 may set a region in the photographed image being contained in the circle as a target region subjected to the character recognition processing.

In addition, when the region in the photographed image indicating the pattern of the pattern region A1 draws a part of a circumference of a circle, the mark recognition unit 21 may estimate the entire circumference of a circle formed so as to include the part of the circumference of the circle, and set a region in the photographed image being contained in the estimated circle as a target region subjected to the character recognition processing.

The registration unit 40 registers a product recognized by the product recognition unit 22 as a checkout target. In other words, the registration unit 40 acquires product information about a product recognized by the product recognition unit 22 from a product master, and registers the product information as a checkout target. The product information includes, for example, a product name, a price, and the like.

It should be noted that, when discount information is acquired by the mark recognition unit 21, the registration unit 40 changes a price of a product registered as a checkout target, based on the discount information acquired by the mark recognition unit 21. Specifically, the registration unit 40 changes a price of the product acquired from the product master, based on the discount information, and registers the changed price as a price of the product.

For example, when discount information acquired by the mark recognition unit 21 is “∘∘ yen discount”, the registration unit 40 registers a price acquired by subtracting ∘∘ yen from a price of the product acquired from the product master, as a price of the product.

When it is recognized that at least a part of the mark M is included in a photographed image, but discount information included in the mark M cannot be acquired, the output unit 30 outputs guidance information for acquiring the discount information. The guidance information can include information indicating that the discount information cannot be acquired. Another example of the guidance information is indicated in description of a flow of processing below. The output unit 30 can output the guidance information via all output apparatuses such as a display and a speaker.

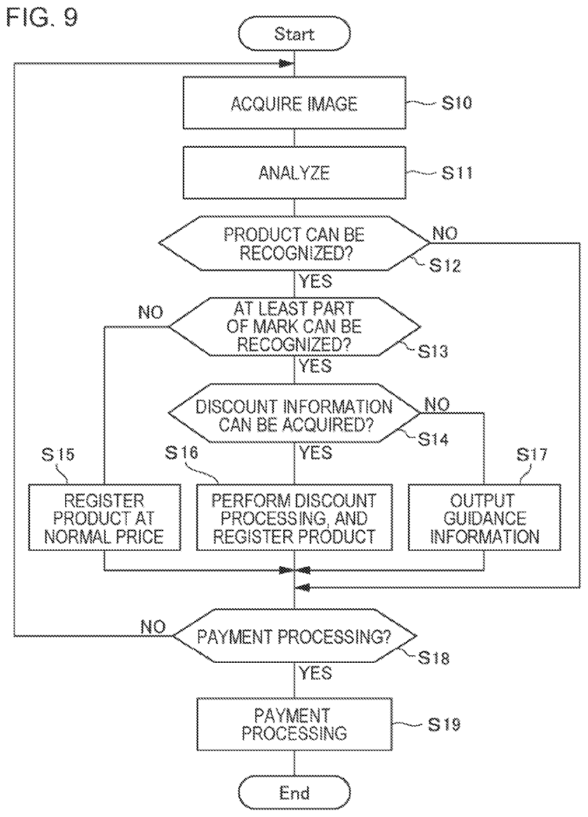

Next, a flow of processing of the registration system 100 will be described by using a flowchart in FIG. 9.

A salesclerk or a customer who is an operator of the registration system 100 performs an operation for photographing a product being a checkout target. For example, the operation may be an operation of placing a product being a checkout target on the member 2 illustrated in FIG. 7, or an operation of holding a product being a checkout target in front of the reading window 5 illustrated in FIG. 8. As a result of the operation, the product being the checkout target is photographed by the camera.

The acquisition unit 10 acquires a photographed image from the camera (S10). Then, the image analysis unit 20 analyzes the photographed image (S11). Specifically, the product recognition unit 22 recognizes a product included in the photographed image. Further, the mark recognition unit 21 recognizes at least a part of the mark M being included in the photographed image. Then, when it can be recognized that at least a part of the mark M is included in the photographed image, the mark recognition unit 21 acquires discount information included in the mark M. It should be noted that details of the processing by the product recognition unit 22 and the mark recognition unit 21 are as described above and will not be thus repeated herein.

As a result of the image analysis in S11, when the product can be recognized (Yes in S12), it can be recognized that at least a part of the mark M is included in the photographed image (Yes in S13), and the discount information can be acquired (Yes in S14), the registration unit 40 acquires product information about the product recognized in S11 from a product master, changes a price of the product included in the acquired product information, based on the discount information, and then registers the product as a checkout target (S16).

As a result of the image analysis in S11, when the product can be recognized (Yes in S12), it can be recognized that at least a part of the mark M is included in the photographed image (Yes in S13), but the discount information cannot be acquired (No in S14), the output unit 30 outputs guidance information for acquiring the discount information (S17).

For example, in S17, the output unit 30 may output the guidance information that prompts rephotographing such as “Discount information cannot be acquired. Rephotograph ∘∘ (product name of recognized product) such that mark M can be recognized”. In this case, the registration unit 40 may not register the product recognized in S11 as a checkout target. In a case of the example, when a photographed image generated by rephotographing is analyzed, the product is registered as a checkout target.

In addition, in S17, the output unit 30 may selectably display, on a display, a plurality of pieces of discount information such as “30 yen discount”, “50 yen discount”, and “half price” together with a message such as “Discount information cannot be acquired. Select discount information attached to ∘∘ (product name of recognized product)”. Then, the input apparatus of the registration system 100 may receive an input that selects any of the pieces of discount information. The registration unit 40 acquires product information about the product recognized in S11 from the product master, changes a price of the product included in the acquired product information, based on the selected discount information, and can then register the product as a checkout target.

As a result of the image analysis in S11, when the product can be recognized (Yes in S12), and it cannot be recognized that at least a part of the mark M is included in the photographed image (No in S13), the registration unit 40 acquires product information about the product recognized in S11 from the product master, and registers the product as a checkout target without changing a price of the product included in the acquired product information (S15).

When a plurality of products are recognized from a photographed image, the processing from S13 to S17 is performed on each of the plurality of recognized products.

As a result of the image analysis in S11, when the product cannot be recognized (No in S12), the processing returns to S10 and similar processing is repeated in a case where there is no input of an instruction for starting a payment (No in S18). It should be noted that, when the configuration in FIG. 7 is assumed, the image analysis unit 20 can distinguish between an object newly placed on the member 2 and an object that continues to be placed on the member 2, based on a time-series change of a photographed image, for example. Then, when a new object is detected, the registration unit 40 registers a new product as a checkout target, based on a recognition result of the object.

When there is an input of the instruction for starting a payment (Yes in S18), the registration system 100 performs payment processing (S19). For example, the registration system 100 may receive an input of cash as a payment of a total payment amount calculated based on products registered until then, and output change or output a receipt as necessary. Further, the registration system 100 may receive an input of a credit card, communicate with a system of a credit company, and perform settlement processing. Further, the registration system 100 may transmit information for payment processing to another payment apparatus. The information for the payment processing includes, for example, information indicating a registered product, a total payment amount, and the like.

The registration system 100 according to the present example embodiment described above is able to perform recognition of presence of the mark M by an image analysis and acquisition of discount information. Such a registration system according to the present example embodiment is able to suppress inconvenience of selling a product being a discount target without giving a discount, without advance registration of the product being the discount target.

Further, when presence of the mark M can be recognized, but discount information cannot be acquired from the mark M, the registration system 100 according to the present example embodiment can output guidance information for acquiring the discount information. Such a registration system according to the present example embodiment is able to suppress inconvenience in which a product being a discount target is sold without giving a discount even though a discount sticker is attached to the product.

### Third Example Embodiment

When it is recognized that at least a part of a mark M is included in a photographed image, but discount information cannot be acquired from the mark M, a registration system 100 according to the present example embodiment can change a content of guidance information to be output according to a state of the mark M in the photographed image. Details will be described below. It should be noted that, in the present example embodiment, a mark M whose at least a part included in a photographed image is recognized, but whose discount information cannot be acquired is referred to as an “information non-acquisition mark”.

One example of a hardware configuration of the registration system 100 according to the present example embodiment is similar to that in the first and second example embodiments.

A functional block diagram of the registration system 100 according to the present example embodiment is illustrated in FIG. 2 or 5 similarly to that in the first and second example embodiments. As illustrated in FIG. 2, the registration system 100 includes an acquisition unit 10 and an output unit 30. Further, as illustrated in FIG. 5, the registration system 100 can include an image analysis unit 20 and a registration unit 40 in addition to the acquisition unit 10 and the output unit 30. A configuration of the acquisition unit 10 and the registration unit 40 is similar to that in the first and second example embodiments.

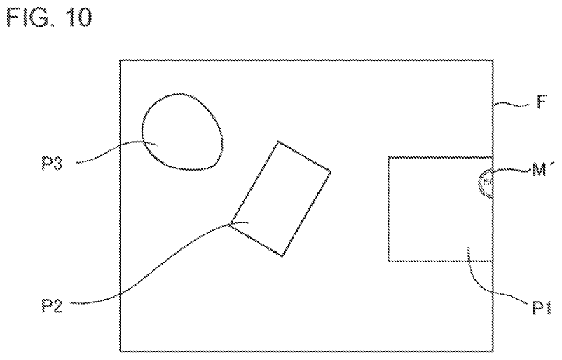

For example, the image analysis unit 20 determines whether an information non-acquisition mark is partly cut off in a photographed image. For example, as illustrated in FIG. 10, when a region in a photographed image in which an information non-acquisition mark M′ is present contacts an end of the photographed image, the image analysis unit 20 can determine that the information non-acquisition mark M′ is partly cut off in the photographed image.

When the information non-acquisition mark M′ is partly cut off in the photographed image, the output unit 30 can output guidance information including an instruction for changing a placement position of a product attached with the information non-acquisition mark M′.

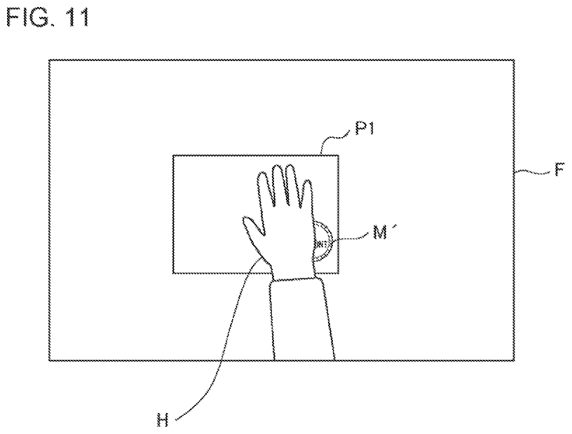

In addition, the image analysis unit 20 analyzes the photographed image, and can recognize a human body such as a hand, for example. Then, the image analysis unit 20 determines whether a positional relationship between the human body recognized in the photographed image and the information non-acquisition mark M′ satisfies a predetermined condition. For example, as illustrated in FIG. 11, when a region in a photographed image in which a detected human body H is present and a region in the photographed image in which the information non-acquisition mark M′ is present contact each other, the image analysis unit 20 can determine that the predetermined condition is satisfied. It should be noted that F is the photographed image, P1 is a product, and H is a hand.

When a positional relationship between the human body included in the photographed image and the information non-acquisition mark M′ satisfies the predetermined condition, the output unit 30 can output guidance information including an instruction for changing a position of the human body.

The other configuration of the image analysis unit 20 and the output unit 30 is similar to that in the first and second example embodiments.

The registration system 100 according to the present example embodiment described above can achieve an advantageous effect similar to that in the first and second example embodiments.

Further, when presence of the mark M is recognized by an image analysis, but discount information cannot be acquired from the mark M, a state of the mark can be determined by the image analysis, and guidance information according to the determined state can be output. Thus, the discount information is highly likely to be acquired by analyzing a photographed image generated by next photographing.

### Fourth Example Embodiment

A registration system 100 according to the present example embodiment can change a content of guidance information to be output according to a recognition result of a mark M by a mark recognition unit 21. Details will be described below.

One example of a hardware configuration of the registration system 100 according to the present example embodiment is similar to that in the first to third example embodiments.

A functional block diagram of the registration system 100 according to the present example embodiment is illustrated in FIG. 2 or 5 similarly to that in the first to third example embodiments. As illustrated in FIG. 2, the registration system 100 includes an acquisition unit and an output unit 30. Further, as illustrated in FIG. 5, the registration system 100 can include an image analysis unit 20 and a registration unit 40 in addition to the acquisition unit 10 and the output unit 30. A configuration of the acquisition unit 10, the image analysis unit 20, and the registration unit 40 is similar to that in the first to third example embodiments.

The output unit 30 outputs guidance information according to a recognition result of the mark M by the mark recognition unit 21.

For example, when a part of the mark M is recognized, and discount information cannot be acquired, the output unit 30 can output the guidance information described in the second example embodiment and the third example embodiment. In addition, the output unit 30 may output guidance information indicating a photographing method such as “Take photograph without moving product”.

Further, when the entire mark M is recognized, but discount information cannot be acquired, the output unit 30 may output guidance information indicating a photographing method such as “Take photograph without moving product”. A situation where the entire mark M is recognized, but discount information cannot be acquired may occur when, for example, the mark M is bluffed due to movement of a product, or the mark M is blurred due to the mark M being out of focus. In such a case, a situation where a pattern of a pattern region A1 can be determined in a photographed image, but discount information cannot be acquired by character recognition processing may occur. In a case of the present example embodiment, appropriate guidance information can be output under such a situation.

Further, while the mark recognition unit 21 performs processing of acquiring discount information after at least a part of the mark M is recognized by the mark recognition unit 21, the output unit 30 may output guidance information indicating that the discount information is being acquired, such as “Discount information is being acquired”. Furthermore, in this case, the output unit 30 may output guidance information that prevents a product from being moved from a current position. Further, the output unit 30 may output guidance information that changes a placement position of a product in such a way that the entire mark M can be recognized.

The registration system 100 according to the present example embodiment described above can achieve an advantageous effect similar to that in the first to third example embodiments.

Further, since the registration system 100 can change a content of guidance information to be output according to a recognition result of the mark M by the mark recognition unit 21, the registration system 100 can output appropriate guidance information according to a situation.

Hereinafter, examples of reference manners are presented as supplementary notes.

1. A registration system, including:

an acquisition unit that acquires an image including a product from a imaging unit; and

an output unit that outputs, when at least a part of a mark including discount information related to the product is included in the image, but the discount information cannot be acquired by an image analysis, guidance information for acquiring the discount information.

2. The registration system according to supplementary note 1, in which

the guidance information includes information indicating that the discount information cannot be acquired.

3. The registration system according to supplementary note 1 or 2, further including

a mark recognition unit that recognizes at least a part of the mark being included in the image, and acquires the discount information included in the mark, in which,

when it is recognized that at least a part of the mark is included in the image, but the discount information included in the mark cannot be acquired, the output unit outputs the guidance information.

4. The registration system according to any of supplementary notes 1 to 3, further including:

a mark recognition unit that recognizes at least a part of the mark being included in the image, and acquires the discount information included in the mark;

a product recognition unit that recognizes a product included in the image; and

a registration unit that recognizes, as a checkout target, the product recognized by the product recognition unit, in which,

when the discount information is acquired, the registration unit changes a price of the product registered as a checkout target, based on the acquired discount information.

5. The registration system according to any of supplementary notes 1 to 4, in which,

when a positional relationship between a human body included in the image and the mark satisfies a predetermined condition, the output unit outputs an instruction for changing a position of the human body.

6. The registration system according to any of supplementary notes 1 to 5, in which,

when the mark is partly cut off in the image, the output unit outputs an instruction for changing a position of the product.

7. A registration method executed by a computer, the method including:

an acquisition step of acquiring an image including a product from a imaging unit; and

an output step of outputting, when at least a part of a mark including discount information related to the product is included in the image, but the discount information cannot be acquired by an image analysis, guidance information for acquiring the discount information.

8. A program causing a computer to function as:

an acquisition unit that acquires an image including a product from a imaging unit; and

an output unit that outputs, when at least a part of a mark including discount information related to the product is included in the image, but the discount information cannot be acquired by an image analysis, guidance information for acquiring the discount information.

This application is based upon and claims the benefit of priority from Japanese patent application No. 2018-090748, filed on May 9, 2018, the disclosure of which is incorporated herein in its entirety by reference.

1. A registration system, comprising:
at least one memory configured to store one or more instructions; and
at least one processor configured to execute the one or more instructions to:
acquire an image including a product from a imaging unit; and
output, when at least a part of a mark including discount information related to the product is included in the image, but the discount information cannot be acquired by an image analysis, guidance information for acquiring the discount information.

2. The registration system according to claim 1, wherein
the guidance information includes information indicating that the discount information cannot be acquired.

3. The registration system according to claim 1,
wherein the processor is further configured to execute the one or more instructions to:
recognize at least a part of the mark being included in the image, and acquire the discount information included in the mark, and
output the guidance information when it is recognized that at least a part of the mark is included in the image, but the discount information included in the mark cannot be acquired.

4. The registration system according to claim 1,
wherein the processor is further configured to execute the one or more instructions to:
recognize at least a part of the mark being included in the image, and acquire the discount information included in the mark;
recognize a product included in the image;
recognize, as a checkout target, the recognized product, and
when the discount information is acquired, change a price of the product registered as a checkout target, based on the acquired discount information.

5. The registration system according to claim 1, wherein the processor is further configured to execute the one or more instructions to output,
when a positional relationship between a human body included in the image and the mark satisfies a predetermined condition, an instruction for changing a position of the human body.

6. The registration system according to claim 1, wherein,
wherein the processor is further configured to execute the one or more instructions to output an instruction for changing a position of the product, when the mark is partly cut off in the image.

7. A registration method executed by a computer, the method comprising:
acquiring an image including a product from a imaging unit; and
outputting, when at least a part of a mark including discount information related to the product is included in the image, but the discount information cannot be acquired by an image analysis, guidance information for acquiring the discount information.

8. A non-transitory storage medium storing a program causing a computer to
acquire an image including a product from a imaging unit; and
output, when at least a part of a mark including discount information related to the product is included in the image, but the discount information cannot be acquired by an image analysis, guidance information for acquiring the discount information.
